(19) United States
(12) Patent Application Publication
(10) Pub. No.: US 2009/0042611 A1
(43) Pub. Date: Feb. 12, 2009

(54) METHOD FOR ORDERING AND PAYING FOR AN ACCESS AUTHORIZATION, FOR CHECKING THE ACCESS AUTHORIZATION, FOR GRANTING AN ACCESS AUTHORIZATION AND/OR FOR PROVIDING ACCESS-RELATED INFORMATION

(75) Inventors: Roland AIGNER, Hallein (AT); Gregor PONERT, Salzburg (AT)

Correspondence Address: DAVIS & BUJOLD, P.L.L.C., 112 PLEASANT STREET, CONCORD, NH, 03301, US

(73) Assignee: SKIDATA AG, Grodig/Salzburg (AT)

(21) Appl. No.: 12/188,571

(22) Filed: Aug. 8, 2008

(30) Foreign Application Priority Data
Aug. 10, 2007 (EP) 07015809.2

(51) Int. Cl. H04M 1/00; H04Q 5/22

(52) U.S. Cl. 455/557; 340/10.1

(57) ABSTRACT

There is proposed a method for ordering and paying for an access authorization, for checking the access authorization, for granting an access authorization and/or for providing access-related information, whereby a data set containing at least one element associated with the access authorization is storable in a mobile telephone or a memory unit associated with the mobile telephone, and the check and/or the granting of the access authorization is effected by a contactless interaction between the mobile telephone and an access control device, whereby, in the case of access control devices in which payment is made upon exit from the place limited by the at least one access control device, the detection of access is carried out upon access via the access control device via an RFID-compliant mobile telephone and the interaction of the mobile telephone with the access control device by means of RFID technology, and whereby, for the purpose of granting and identifying the access authorization and for payment thereof, a one-to-one transaction number associated with the access authorization is used which is transmissible contactlessly from the mobile telephone to another mobile telephone.

The present invention relates to a method for ordering and paying for an access authorization, for checking the access authorization, for granting an access authorization and/or for providing access-related information, according to the preamble of claim 1.

From the prior art it is known to transmit admission tickets for events, after they have been ordered, to the customer's mobile telephone in electronic form and store them there. By an interaction of the mobile telephone containing the electronic ticket with the corresponding access control device, the user's access authorization is checked and, if the admission ticket is valid, admission is granted. The interaction between the mobile telephone and the access control device is carried out contactlessly, for example via an RFID method, via Bluetooth®, etc.

For example, EP 1166238 B1 discloses a method for ordering, loading and using admission tickets for access to access-controlled service devices by which admission tickets are stored in a memory module of a mobile communications terminal and data are exchanged between said memory module and a reading device of an access-controlled service device via a contactless interface, the admission ticket being ordered from a reservation center through transmission of order information to said reservation center, the order information containing the call number of the user's mobile communications terminal. After the order has been made the ordered admission ticket is transmitted according to EP 1166238 B1 via a mobile network to that mobile communications terminal to which the call number contained in the order information is assigned.

This known method has the disadvantage that it is absolutely necessary to state the call number. Firstly, it is possible that the user makes a typing error when entering the number; secondly, it is usual nowadays that a phone number (MSISDN number) has a plurality of SIM cards associated therewith (a first SIM card being provided for example for the car telephone and a further SIM card for the user's mobile telephone). By carrying out the method according to EP 1166238 B1 it can therefore happen that the electronic ticket is transmitted to two mobile telephones and stored there, or that it is transmitted to the wrong mobile telephone that is inaccessible at the desired time.

Furthermore, the known method is not applicable in situations where payment is only to be made after receipt of the service, for example in car parks with access control devices in which the sum to be paid is determined in dependence on the parking time.

EP 0950968 A1 discloses a mobile electronic commerce system in which an electronic ticket is stored in a mobile telephone, the user's access authorization being determined by an interaction of the mobile telephone with an access control device. Payment of the ticket is made via a paycard or via the telephone bill of the mobile telephone. These known methods also necessitate that the mobile phone number is stated so that the electronic ticket can be transmitted to the mobile telephone; moreover, the known method is not applicable in situations where payment is only to be made after receipt of the service.

EP 1424657 A1 from the applicant, whose disclosure is in all points also to be the subject matter of this description, discloses an electronic ticket for RFID systems for data interchange with a reading device, the ticket being constituted by a mobile telephone with a microprocessor, a memory and a coding and decoding device, and the mobile telephone having integrated therein via an application interface an additional hardware and a software for simulating an electronic ticket for RFID systems for data interchange with the reading device. The additional hardware comprises an RFID antenna as well as a transmitter and a receiver as an interface to the RFID antenna; the transmitter and the receiver are advantageously connected directly to the coding and decoding device of the mobile telephone.

The present invention is based on the object of specifying a method for ordering and paying for an access authorization, for checking the access authorization, for granting an access authorization and/or for providing access-related information, whose implementation avoids the above-mentioned disadvantages of the methods known from the prior art. It is a further objective of the invention to specify a method that can be carried out in situations where payment is only to be made after granting of the access authorization or after receipt of the service.

This object is achieved by the features of claims 1, 2 and 12 and 13. Further embodiments and advantages are indicated by the corresponding subclaims.

Thus, there is proposed according to the invention a method wherein a data set containing at least one element associated with the access authorization is storable in a mobile telephone or a memory unit associated with the mobile telephone, and the check and/or the granting of the access authorization is effected by a contactless interaction between the mobile telephone and an access control device, whereby in the case of access control devices in which payment is made upon exit from the place limited by the at least one access control device, the detection of access is carried out upon access via the access control device via an RFID-compliant mobile telephone and the interaction of the mobile telephone with the access control device by means of RFID technology. Instead of an RFID-compliant mobile telephone it is also possible to use other RFID-compliant devices for mobile communication, such as a PDA or a Pocket PC.

The memory unit associated with the mobile telephone can be for example the SIM card of the telephone, a security module, a secure memory, for example an SD card, or a memory module of the telephone. According to the invention there is used, for the purpose of granting and identifying the access authorization and for payment thereof, a one-to-one transaction number associated with the access authorization and constituting an element, associated with the access authorization, of the data set storable in the mobile telephone.

It is at the same time provided that the transaction number is transmissible contactlessly from the mobile telephone to another mobile telephone. This ensures that payment of the access authorization can be made by another person, which is relevant in particular in situations where the access relates not to a person, but to a non-person-related service, as is the case for example with the provision of parking spaces. Thus, a first person can drive a vehicle into a car park and a second person can pay and drive out on the basis of the transaction number.

The transaction number can be transmitted from the mobile telephone by means of which the access has been detected to another mobile telephone via the GSM network, e.g. as an SMS message, by means of RFID technology, e.g. NFC technology, via an infrared connection, via a Bluetooth® connection or via another mobile telephone connection technology.

Furthermore, it is provided that upon exit from the place limited by the at least one access control device, the access authorization is identified by means of an RFID interaction between the access control device and a mobile telephone containing the transaction number, the required payment being made via RFID technology and credit-card or bank-account data stored in the mobile telephone containing the transaction number which are transmitted to the access control device, via a direct payment via the phone number of the mobile telephone containing the transaction number, via an Internet connection established by means of the mobile telephone containing the transaction number, via a cash payment or by initiating a credit-card transaction by reading of the credit-card data from a machine-readable or RFID-readable credit card. After payment has been made, exit is granted by the access control device.

In the case of access control devices in which payment can be made at a payment device or a machine before exit from the place limited by the at least one access control device, which can also be the case in a car park, the detection of access is effected according to the invention upon access via an access control device via an RFID-compliant mobile telephone and the interaction of the mobile telephone with the access control device by means of RFID technology, whereby, for the purpose of identifying the access authorization and for payment thereof, a one-to-one transaction number associated with the access authorization is used which is transmissible contactlessly from the mobile telephone to another mobile telephone. For a payment to be carried out, the access authorization is identified by means of an RFID interaction between a payment device and a mobile telephone containing the transaction number. After identification of the access authorization by the transaction number, the payment can be made via credit-card or bank-account data stored in the mobile telephone containing the transaction number which are transmitted to a payment device, via a direct payment via the phone number of the mobile telephone containing the transaction number, via an Internet connection established by means of the mobile telephone containing the transaction number, via a cash payment or by initiating a credit-card transaction by reading of the credit-card data from a machine-readable or RFID-readable credit card.

In an advantageous development of the invention, it is proposed that after payment has been made the payment device transmits a receipt in electronic form via RFID technology to the RFID-compliant mobile telephone containing the transaction number, whereby, upon exit from the place limited by the at least one access control device, the access authorization is identified via RFID technology by means of the mobile telephone containing the transaction number, and it is checked by means of an RFID interaction with reference to the receipt in electronic form stored in the mobile telephone whether the required payment has been made. The receipt can contain the transaction number. It is also possible to transmit the receipt in electronic form and optionally the transaction number, after payment has been made, to another mobile telephone by means of which the check of payment is effected for the purpose of the granting of exit by the access control device.

According to a further embodiment of the invention, instead of creating and transmitting the receipt in electronic form after payment has been made, the payment device can transmit, via a local area or wide area network, a signal to the at least one access control device or to a computer connected to the access control device (e.g. to a server), containing the transaction number as well as the information that payment has been made for the access authorization associated with the transaction number, so that after an RFID interaction between a mobile telephone containing the transaction number and the access control device, tie user can leave the place limited by the access control device.

The transaction number can, in all described cases, be generated and transmitted from the access control device to the mobile telephone via RFID technology upon detection of access, whereby, in the case of an access authorization booked before access, the transaction number is generated and transmitted to the user's mobile telephone upon booking. Alternatively, the transaction number can be generated on the basis of booking data stored in the mobile telephone, and transmitted to the mobile telephone, by the access control device upon detection of access. The access control device is at this time connected to a computer of the booking system, so that, in the case of an access authorization booked before access, the data stored in the booking system are compared with the transaction number or with booking data stored in the mobile telephone for checking the booking or the access authorization.

According to the invention, it is possible, in the case of an access authorization booked or pre-reserved before access, that a serial number of the mobile telephone and/or of the SIM card and/or of the memory module of the mobile telephone is transmitted, upon detection of access, by means of RFID technology to the access control device and preferably to a computer connected to the access control device, and compared with corresponding data stated upon booking to check the validity of the booking.

It is also possible according to the invention that upon detection of access a serial number of the mobile telephone and/or of the SIM card and/or of a safety memory (for example of an SD card) and/or of the memory module of the mobile telephone is transmitted by means of RFID technology to the access control device and preferably to a computer connected to the access control device, regardless of whether or not a booking is present, in order to document the access process.

Furthermore, it can be provided that a receipt in paper form is issued by the payment device or by the access control device.

In an advantageous development of the invention, it can be provided that upon detection of access to the place limited by the at least one access control device, a counter and/or a software, for example an applet, is started, or can be started, via RFID technology on the mobile telephone containing the transaction number via which the detection is effected, thereby permitting the user to inform himself of the accruing charges any time.

Furthermore, it can be provided that upon detection of access upon entry to the place limited by the at least one access control device, access-related information is transmitted via RFID technology to the mobile telephone via which the detection of access is effected (and which contains the transaction number); said information can be for example information about vacant parking spaces in a car park or ones pre-reserved by the user, optionally containing a description of the way to said parking spaces, or it can be more general information regarding modalities of payment and the like.

Furthermore, it is proposed according to the invention to give the user of a mobile telephone the possibility of pre-reserving in advance a certain space in a place limited by at least one access control device. For example, it is possible to pre-reserve a certain parking space, a parking space in a certain area of a car park, a certain seat in a concert hall or stadium. This can be very advantageous in particular when the car park involved is an airport car park; the inventive method permits the user to pre-reserve a parking space near the take-off gates, which results in a considerable time saving.

In this case the user can make the pre-reservation by means of his mobile telephone via an Internet connection, which is initiated for example by the interaction of his mobile telephone with an RFID label e.g. attached to a card and containing a corresponding Internet link. It can at the same time be provided that there is a charge for the pre-reservation which can be paid right away online, or can be paid together with the charges due for the access authorization upon exit from the place limited by the at least one access control device.

The pre-reservation data are stored in electronic form in the user's mobile telephone or in a memory unit associated with the mobile telephone and, upon entry to the place limited by the at least one access control device, checked by the access control device during the detection of access for identifying the pre-reservation by means of an RFID interaction between the mobile telephone and the access control device; as explained above, a description of the way to the pre-reserved space can be transmitted to the user's mobile telephone via RFID technology.

In the case of access control devices in which payment is made before entry to the place limited by the access control devices, as is the case for example with concerts or sporting events, it is provided according to the invention that a data set containing at least one element associated with the access authorization is transmitted to a mobile telephone in electronic form, this being preferably effected by establishment of an Internet connection between a mobile telephone and an Internet page offering the access authorization for ordering and paying for the access authorization, by an RFID interaction between the mobile telephone and a device for selling the access authorization for ordering and paying for the access authorization or by a contactless transmission, for example by a Bluetooth®, an RFID or an infrared transmission, from a computer by means of which the access authorization is ordered and paid for.

Upon entry to the place limited by the at least one access control device, the check of the access authorization and granting of access is effected by means of an RFID interaction between a mobile telephone containing the data set and the access control device, whereby, for the purpose of identifying the access authorization, a one-to-one transaction number associated with the access authorization is used which is generated and transmitted to the user's mobile telephone upon ordering and payment of the access authorization, or generated on the basis of the data of the data set and transmitted to the mobile telephone by the access control device upon detection of access.

In the case of access control devices in which payment is only made upon entry to the place limited by the at least one access control device, the ordering of the access authorization is effected via an RFID interaction between an access control device and a mobile telephone; the payment of the access authorization is carried out via an RFID interaction between the access control device and the mobile telephone and credit-card or bank-account data stored in the mobile telephone which are transmitted to the access control device, via a direct payment via the phone number of the mobile telephone, via a cash payment or by initiating a credit-card transaction by reading of the credit-card data from a machine-readable or RFID-readable credit card, whereby, after payment has been made, a one-to-one transaction number associated with the access authorization is generated and transmitted to the mobile telephone, whereby access is granted.

Advantageously, according to a development of the invention, in the case of access control devices in which payment is made before or upon entry to the place limited by the access control devices, the transaction number associated with the access authorization, or the data contained in the data set, are transmissible contactlessly, before access to the place limited by the at least one access control device, from the mobile telephone to another mobile telephone via which access is then effected.

Preferably, the transaction number associated with the access authorization, or the data of the data set, are transmissible from the mobile telephone to another mobile telephone via the GSM network, by means of RFID technology, via an infrared connection, via a Bluetooth® connection, or via another mobile telephone connection technology.

Furthermore, in a variant of the inventive method, in the case of access control devices in which payment is made before or upon entry to the place limited by the access control devices, it is provided that access-related information is transmitted via RFID technology from an access control device to the mobile telephone containing the transaction number during the access authorization checking process. For example, upon entry to a concert hall, stadium or transport means a user can obtain information leading him to a vacant seat or to a pre-reserved seat. It is also possible that in the case of an event the user in this way obtains information about how the event will proceed and about available offers.

In all variants of the inventive method the ordering of the access authorization is effected without the necessity of stating a phone number.

The RFID technology used can be any RFID technology, it being preferable to use NFC technology (NFC technology standing for near field communication technology, which is a well-known radio technology for short distances based on RFID radio technology).

Furthermore, the inventive method can be carried out using an RFID-compliant mobile telephone configured according to EP 1424657 A1 from the applicant, having integrated therein via an application interface an additional hardware and a software for simulating an electronic ticket for RFID systems for data interchange with the reading device or with an access control device. The additional hardware comprises an RFID antenna as well as a transmitter and a receiver as an interface to the RFID antenna, the transmitter and the receiver being connected directly to the coding and decoding device of the mobile telephone.

1.-19. (canceled)

20. A method for at least one of ordering and paying for an access authorization, for checking the access authorization, for granting an access authorization and for providing access-related information, whereby a data set containing at least one element associated with the access authorization is storable in a mobile telephone or a memory unit associated with the mobile telephone, and one of the check and the granting of the access authorization is effected by a contactless interaction between the mobile telephone and an access control device,
wherein, in the case of access control devices in which payment is made upon exit of the place limited by the at least one access control device, the detection of access is carried out upon access via the access control device via an REID-compliant mobile telephone and the interaction of the mobile telephone with the access control devices by means of RFID technology, whereby, for the purpose of granting and identifying the access authorization and for payment thereof, a one-to-one transaction number associated with the access authorization is used which is transmissible contactlessly from the mobile telephone to another mobile telephone, whereby, upon exit from the place limited by the at least one access control device, the access authorization is identified by means of an RFID interaction between the access control device and a mobile telephone containing the transaction number, whereby the required payment is made via RFID technology and credit-card or bank-account data stored in a mobile telephone containing the transaction number which are transmitted to the access control device, via a direct payment via the phone number of the mobile telephone containing the transaction number, via an Internet connection established by means of the mobile telephone containing the transaction number, via a cash payment or by initiating a credit-card transaction by reading of the credit card data from a machine-readable or RFID-readable credit card.

21. A method for ordering and paying for an access authorization, for checking the access authorization, for granting an access authorization and/or for providing access-related information, whereby a data set containing at least one element associated with the access authorization is storable in a mobile telephone or a memory unit associated with the mobile telephone, and the check and/or the granting of the access authorization is effected by a contactless interaction between a mobile telephone and an access control device, wherein, in the case of access control devices in which payment is made at a payment device before exit from the place limited by the at least one access control device, the detection of access is carried out upon access via the access control device via an RFID-compliant mobile telephone and the interaction of the mobile telephone with the access control device by means of RFID technology, whereby, for the purpose of identifying the access authorization and for payment thereof, a one-to-one transaction number associated with the access authorization is used which is transmissible contactlessly from the mobile telephone to another mobile telephone, whereby for the purpose of payment the access authorization is identified by means of an RFID interaction between a payment device and a mobile telephone containing the transaction number, whereby the payment is made via credit-card or bank-account data stored in a mobile telephone containing the transaction number which are transmitted to a payment device, via a direct payment via the phone number of the mobile telephone containing the transaction number, via an Internet connection established by means of the mobile telephone containing the transaction number, via a cash payment or by initiating a credit-card transaction by reading of the credit-card data from a machine-readable or RFID-readable credit card, and whereby, after payment has been made, the receipt is transmitted in electronic form from the payment device via RFID technology to the RFID-compliant mobile telephone containing the transaction number, and whereby, upon exit from the place limited by the at least one access control device, the access authorization is identified via RFID technology by means of a mobile telephone containing the transaction number, and it is checked by means of an RFID interaction with reference to the receipt in electronic form stored in the mobile telephone whether the required payment has been made.

22. The method according to claim 21, further comprising the step of, instead of creating and transmitting the receipt in electronic form, after payment has been made the payment device transmits a signal to the at least one access control device or to a computer connected to the access control device, containing the transaction number as well as the information that payment has been made for the access authorization associated with the transaction number, so that after an RFID interaction between a mobile telephone containing the transaction number and the access control device the user can leave the place limited by the access control device.

23. The method according to claim 20, further comprising the step of generating the transaction number and transmitting from the access control device via RFID technology to the mobile telephone upon detection of access, or, in the case of an access authorization booked or pre-reserved before access, the transaction number is generated and transmitted to the user's mobile telephone upon booking, or it is generated on the basis of booking data stored in the mobile telephone, and transmitted to the mobile telephone, by the access control device upon detection of access.

24. The method according to claim 20, further comprising the step of transmitting one of a serial number of the mobile telephone or of the SIM card, of a secure memory and of the memory module of the mobile telephone to the access control device by means of RFID technology upon detection of access.

25. The method according to claim 20, further comprising the step of, upon detection of access to the place limited by the at least one access control device, starting a counter and/or a software, via RFID technology on the mobile telephone containing the transaction number, thereby permitting the user to inform himself of the accruing charges at any time.

26. The method according to claim 20, further comprising the step of, upon detection of access to the place limited by the at least one access control device, transmitting access-related information via RFID technology to the mobile telephone containing the transaction number.

27. The method according to claim 20, further comprising the step of making a pre-reservation for a certain space or seat in the place limited by the at least one access control device via an Internet connection by means of a mobile telephone.

28. The method according to claim 27, further comprising the step of initiating establishment of the Internet connection by the interaction of the mobile telephone with an RFID label containing a corresponding Internet link.

29. The method according to claim 27, further comprising the step, in the case that there is a charge for the pre-reservation, paying for the charge online upon making of the pre-reservation or upon exit or before exit from the place limited by the at least one access control device together with the charges due.

30. The method according to claim 27, further comprising the step of storing the pre-reservation data in electronic form in the mobile telephone or in a memory unit associated with the mobile telephone, and, upon access to the place limited by the at least one access control device, checked by the access control device during the detection of access for identifying the pre-reservation by means of an RFID interaction.

31. A method for ordering and paying for an access authorization, for checking the access authorization, for granting an access authorization and/or for providing access-related information, whereby a data set containing at least one element associated with the access authorization is storable in a mobile telephone or a memory unit associated with the mobile telephone, and the check and/or the granting of the access authorization is effected by a contactless interaction between the mobile telephone and an access control device, wherein, in the case of access control devices in which payment is made before entry to the place limited by the at least one access control device, a data set containing at least one element associated with the access authorization is transmitted in electronic form to a mobile telephone, whereby this is effected by establishment of an Internet connection between the mobile phone and an Internet page offering the access authorization for ordering and paying for the access authorization, by an RFID interaction between the mobile telephone and a device for selling the access authorization for ordering and paying for the access authorization, or by a contactless transmission from a computer by means of which the access authorization is ordered and paid for, and whereby, upon entry to the place limited by the at least one access control device, the check of the access authorization and granting of access is effected by means of an RFID interaction between a mobile telephone containing the data set and the access control device, whereby, for the purpose of identifying the access authorization, a one-to-one transaction number associated with the access authorization is used which is generated and transmitted to the user's mobile telephone upon ordering and payment of the access authorization, or generated on the basis of the data of the data set and transmitted to the mobile telephone by the access control device upon detection of access.

32. A method for ordering and paying for an access authorization, for checking the access authorization, for granting an access authorization and/or for providing access related information, whereby a data set containing at least one element associated with the access authorization is storable in a mobile telephone or a memory unit associated with the mobile telephone, and the check and/or the granting of the access authorization is effected by a contactless interaction between the mobile telephone and an access control device, wherein, in the case of access control devices in which payment is made before entry to the place limited by the at least one access control device, the ordering of the access authorization is effected via an RFID interaction between an access control device and the mobile telephone, whereby the payment of the access authorization is effected via an RFID interaction between the access control device and the mobile telephone and credit-card or bank-account data stored in the mobile telephone which are transmitted to the access control device, via a direct payment via the phone number of the mobile telephone, via a cash payment or by initiating a credit-card transaction by reading of the credit-card data from a machine-readable or RFID-readable credit card, whereby, after payment has been made, a one-to-one transaction number associated with the access authorization is generated and transmitted to the mobile telephone, whereby access is granted.

33. The method according to claim 31, further comprising the step of transmitting access-related information from the access control device via RFID technology to the mobile telephone containing the transaction number during the access authorization checking process.

34. The method according to claim 33, further comprising the step of the access-related information leading the user to a vacant space or seat or to one that is pre-reserved or associated with the access authorization.

35. The method according to claim 31, further comprising the step of transmitting the transaction number associated with the access authorization, or the data of the data set, contactlessly, before access to the place limited by the at least one access control device, from the mobile telephone to another mobile telephone via which access is then effected.

36. The method according to claim 35, further comprising the step of transmitting the transaction number associated with the access authorization, or the data of the data set, from the mobile telephone to another mobile telephone via the GSM network, by means of RFID technology, via an infrared connection, via a Bluetooth® connection, or via another mobile telephone connection technology.

37. The method according to claim 20, further comprising the step of using NFC technology as the RFID technology.

38. The method according to claim 20, further comprising the step of carrying out the method using a mobile telephone having integrated therein via an application interface an additional hardware and a software for simulating an electronic ticket for RFID systems for data interchange with the reading device or with an access control device, the additional hardware comprising an RFID antenna, a transmitter and a receiver being connected directly to the coding and decoding device of the mobile telephone.
